(19) United States
(12) Patent Application Publication
(10) Pub. No.: US 2006/0290137 A1
(43) Pub. Date: Dec. 28, 2006

(54) Threaded coupling for receptacles, such as expansion vessels, tanks and the like

(75) Inventor: Ugo Benettolo, Padova (IT)

Correspondence Address: MODIANO & ASSOCIATI, Via Meravigli, 16, MILAN, 20123, IT

(73) Assignee: ZILMET S.P.A.

(21) Appl. No.: 11/449,607

(22) Filed: Jun. 9, 2006

(30) Foreign Application Priority Data
Jun. 24, 2005 (IT) PD2005A000191

(51) Int. Cl. F16L 5/00

(52) U.S. Cl. 285/204; 285/201; 285/189

(57) ABSTRACT

A threaded coupling for receptacles comprising a tubular duct adapted to connect the internal chamber of the receptacle to an intake/discharge pipe, the duct having, at one end, a threaded portion arranged outside the dome-shaped part of the receptacle. The coupling has an externally threaded tubular collar, fixed externally to the dome-shaped part, a tubular insert coaxial thereto with an end arranged inside the dome-shaped part, a flange for locking the internal lining of the chamber by interposing a sealing element.

### BACKGROUND OF THE INVENTION

Threaded couplings for expansion vessels, tanks and the like are currently known which are constituted by a tubular duct adapted to connect the internal chamber of an expansion vessel, tank or other similar containment body to an intake/discharge pipe, for example of a hydraulic system.

The duct has, at one end, a threaded portion suitable to be arranged outside a dome-shaped part of the vessel, tank or the like, for fixing to a complementarily threaded female thread for connection to the system, and has, at the opposite end, a flange suitable to lock an internal lining for sealing and protecting the vessel or tank against the internal surface of said dome-shaped part.

Such expansion vessel or tank is in fact generally intended to contain liquid or gaseous fluids, the direct contact of which with the outer metallic enclosure would damage said enclosure.

At least one sealing element is generally interposed between the flange and the lining or between the lining and the dome-shaped part.

Although these known couplings are extensively used and appreciated, they have drawbacks.

The locking flange of the internal lining is in fact generally obtained by clinching the end of the tubular duct, the opposite end of which is provided with a thread and with a shoulder for abutment against the outer surface of the dome-shaped part of the vessel or tank.

Such flange is adapted to press a sealing ring directly against the lining, or with the interposition of a protective ring made of metallic material for the sealing ring.

In the first case, the flange obtained by clinching may have cracks due to the particular cold working, which expose the sealing ring to the action of the fluid contained within the vessel or tank.

In the second case, the flange is in contact with a protective ring, i.e., with an additional component of the coupling, which increases its efficiency but also increases its cost.

### SUMMARY OF THE INVENTION

The aim of the present invention is to provide a threaded coupling for expansion vessels, tanks and the like that is capable of obviating the drawbacks of known types of coupling.

Within this aim, an object of the present invention is to provide a threaded coupling in which the sealing element is well-protected against the fluid that is present in the vessel or tank.

Another object of the present invention is to provide a threaded coupling that does not require additional components for protection of the sealing element.

Another object of the present invention is to provide a threaded coupling that is not less efficient than known types of coupling.

A further object of the present invention is to provide a threaded coupling that is simple to fit to an expansion vessel, tank or the like.

A still further object of the present invention is to provide a threaded coupling for expansion vessels, tanks and the like that can be manufactured cheaply with known systems and technologies.

This aim and these and other objects, which will become better apparent hereinafter, are achieved by a threaded coupling for receptacles, such as expansion vessels, tanks and the like, of the type that comprises a tubular duct adapted to connect the internal chamber of an expansion vessel, tank or the like to an intake/discharge pipe, said duct having, at one end, a threaded portion adapted to be arranged outside a dome-shaped part of the expansion vessel, tank or the like, said threaded coupling being characterized in that it is composed of:
an externally threaded tubular collar, which is fixed externally to the dome-shaped part so as to form said threaded portion,
a tubular insert, which forms said tubular duct, that passes coaxially through said tubular collar, and has, at its end arranged inside the dome-shaped part, a flange for locking the internal sealing and protection lining by interposing at least one sealing element between the lining and the dome-shaped part or between the flange and the lining,

said tubular insert having, at its outer end, which protrudes from said threaded tubular collar, an extraction-preventing shoulder suitable to abut against the upper edge of said threaded tubular collar in order to lock said insert and the internal lining to the dome-shaped part.

### BRIEF DESCRIPTION OF THE DRAWINGS

Further characteristics and advantages of the invention will become better apparent from the following detailed description of a preferred but not exclusive embodiment thereof, illustrated by way of non-limiting example in the accompanying drawings, wherein:

FIG. 1 is a sectional side view of a coupling according to the invention in a first embodiment thereof;

FIG. 2 is an exploded version of the sectional side view of FIG. 1;

FIG. 3 is a view of a detail of a second embodiment of a coupling according to the invention.

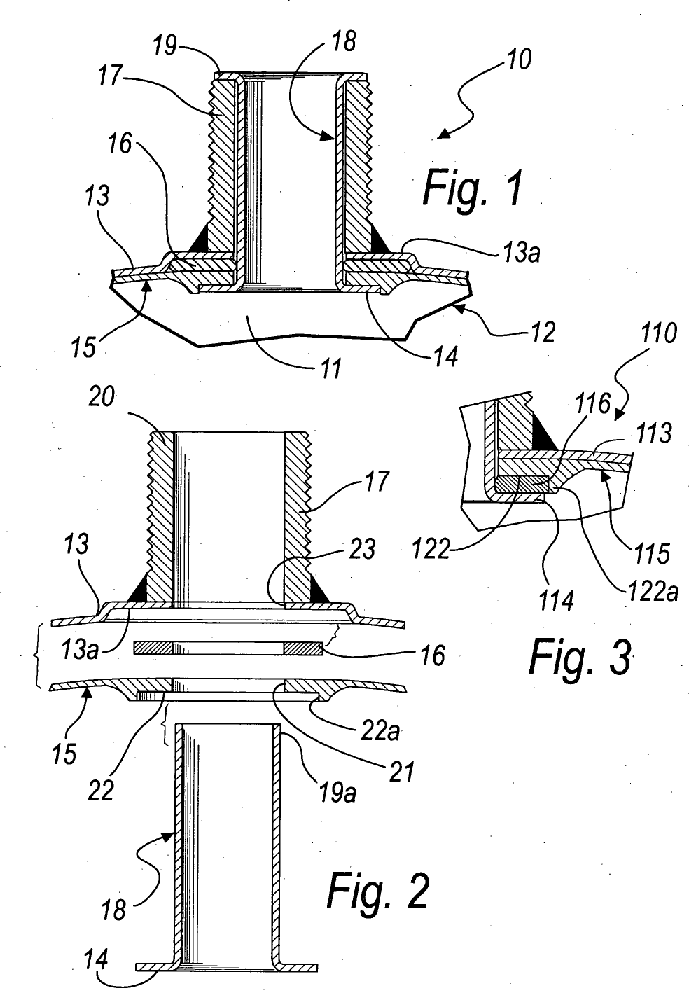

### DESCRIPTION OF THE PREFERRED EMBODIMENTS

With reference to the figures, a threaded coupling for receptacles, such as expansion vessels, tanks and the like according to the invention is generally designated by the reference numeral 10.

The threaded coupling 10 comprises a tubular duct, which is adapted to connect an internal chamber 11 of an expansion vessel, tank or the like 12 to an intake/discharge pipe.

The duct has, at a first end thereof, a threaded portion suitable to be arranged outside a dome-shaped part 13 of the expansion vessel, tank or the like 12, and has, at the second, opposite end, a flange 14 adapted to lock an internal lining 15 made of plastic material for sealing and protection against the internal surface of the dome-shaped part 13.

The internal lining 15, in the present embodiment, is made of polypropylene.

In this first embodiment, a sealing element 16 is provided in a sealing position between the lining 15 and the dome-shaped part 13 and is constituted by a rubber ring or O-Ring or other equivalent gasket.

The dome-shaped part 13 is provided with an annular seat 13a, obtained by drawing during the molding of the dome-shaped part 13, for accommodating the sealing element 16.

In the seat 13a, the sealing element 16 is completely protected against the fluid inside the vessel or tank by means of the lining 15.

In the second embodiment of the coupling 110 according to the invention, shown in FIG. 3, the sealing element 116 is interposed in a sealing position between the internal lining 115 and the flange 114, so that the lining faces the dome-shaped part 113.

The threaded portion is formed by a tubular collar 17, which is threaded externally, is fixed externally to the dome-shaped part 13, and is adapted to be crossed substantially coaxially by a tubular insert 18.

The externally threaded tubular collar 17 is made of metallic material with suitable chemical-physical resistance properties, and in particular of stainless steel or carbon steel, and is fixed to the dome-shaped part 13 by welding.

The tubular insert 18 forms said tubular duct and has, at its end arranged inside the dome-shaped part 13, the flange 14 for locking the internal lining 15.

The tubular insert 18 and the flange 14 are a single-monolithic body made of stainless steel.

The flange 14 is provided on the insert 18 by drawing, therefore with cold stamping operations, which allow to avoid or at least limit the formation of cracks on the flange 14.

In this manner, the sealing element 16 is completely protected, differently from what occurs with known types of coupling, in which the flange 14 is obtained by clinching on the sealing element 16 and it is necessary to resort to the interposition of a protective ring.

An extraction-preventing shoulder 19 is provided at the outer end of the tubular insert 18, i.e., at the end that exits from the threaded tubular collar 17, and is suitable to abut against the upper edge 20 of the threaded tubular collar 17 in order to lock the internal lining 15 to the dome-shaped part 13.

The shoulder 19 is obtained by clinching, against the upper edge 20 of the tubular collar 17, an annular end portion 19a of the tubular insert 18, which protrudes from the collar 17 at the end of the insertion of the insert 18 in holes 21 in the lining and holes 23 in the dome-shaped part 13, and through the collar 17.

Therefore, clinching to lock the sealing element 16 and the lining is not performed against the sealing element 16, or with the interposition of an additional protective ring as in known types of coupling, but by machining the outer end of the tubular insert 18 against the threaded collar 17.

Between the upper edge 20 of the collar 17 and the shoulder 19 there are no sealing elements that can be damaged in the clinching operation, and any cracks on the shoulder 19, generally produced by clinching, are not dangerous, indeed because the task of the shoulder 19 is to lock the insert 18 but not also to protect an adjacent element.

The internal lining 15 has, at the hole 21 for the passage of the tubular insert 18, a seat 22 which is adapted to receive the flange 14 of the tubular insert 18.

The seat 22 allows to achieve stable positioning of the insert 18, also optimizing its efficiency.

In the second embodiment of FIG. 3, moreover, the seat 122, by means of its annular shoulder 122a, protects the sealing element 116 perimetrically, while the flange 114 protects the sealing element 116 in an axial direction.

The seat 22 and 122 can be obtained easily directly during the molding of the internal lining 15.

In practice it has been found that the invention thus described solves the problems noted in known types of threaded coupling for expansion vessels, tanks and the like.

In particular, the present invention provides a threaded coupling in which the sealing element is well-protected against the fluid that is present in the vessel or tank.

Moreover, the present invention provides a threaded coupling that does not require additional components to protect the sealing element.

Moreover, the present invention provides a threaded coupling that is not less efficient than known types of coupling.

Further, the present invention provides a threaded coupling that is simple to fit to an expansion vessel, tank or the like, even of a known type.

Moreover, the present invention provides a threaded coupling for expansion vessels, tanks and the like that can be manufactured cheaply with known systems and technologies.

The invention thus conceived is susceptible of numerous modifications and variations, all of which are within the scope of the appended claims; all the details may further be replaced with other technically equivalent elements.

In practice, the materials employed, so long as they are compatible with the specific use, as well as the dimensions, may be any according to requirements and to the state of the art.

The disclosures in Italian Patent Application No. PD2005A000191 from which this application claims priority are incorporated herein by reference.

What is claimed is:

1. A threaded coupling for receptacles, comprising: an internal chamber provided with an internal sealing and protection lining; at least one sealing element; a tubular duct adapted to connect the internal chamber to an intake/discharge pipe, connectable to the receptacle, said duct having, at a first end thereof, a threaded portion suitable to be arranged outside a dome-shaped part of the receptacle; an externally threaded tubular collar, which is fixed externally to said dome-shaped part of the receptacle so as to form said threaded portion of the duct, said tubular duct being formed by a tubular insert that passes coaxially through said tubular collar; a flange provided at a second end of the duct arranged inside the dome-shaped part, said flange for locking the internal sealing and protection lining by interposition of said at least one sealing element arranged in a sealing position, said sealing position being selected from a position between the lining and the dome-shaped part and a position between the flange and the lining; an extraction-preventing shoulder provided at an outer end of said tubular insert which protrudes from said threaded tubular collar, said shoulder being suitable to abut against an upper edge of said threaded tubular collar in order to lock said insert and the internal lining to the dome-shaped part.

2. The threaded coupling of claim 1, wherein said shoulder is formed by an annular end portion of the tubular insert that protrudes from said collar that is clinched against the upper edge of the tubular collar.

3. The threaded coupling of claim 2, comprising one said sealing element, the sealing element being interposed between the internal lining and an internal surface of the dome-shaped part.

4. The threaded coupling of claim 2, comprising one said sealing element, the sealing element being interposed between the flange of the tubular insert and the internal lining.

5. The threaded coupling of claim 2, wherein said internal lining has a hole for passage of the tubular insert and a seat that surrounds said hole and which is adapted to receive selectively said flange, said sealing element or both the flange and sealing element.

6. The threaded coupling of claim 2, wherein said internal lining is made of plastic material.

7. The threaded coupling of claim 6, wherein said tubular insert and said flange are provided as a single body made of a material selected from a group comprising stainless steel, carbon steel and other metallic material with suitable resistance properties.

8. The threaded coupling of claim 7, wherein said flange is drawing formed on said insert.

9. The threaded coupling of claim 1, wherein said externally threaded annular collar is provided fixed to the dome-shaped part, by welding.

10. The threaded coupling of claim 1, wherein said sealing element is formed by a rubber ring.
